(19) United States
(12) Patent Application Publication
(10) Pub. No.: US 2026/0225661 A1
(43) Pub. Date: Aug. 6, 2026

(54) VEHICLE BODY STRUCTURE

(71) Applicants: Hyundai Motor Company, Seoul (KR); Kia Corporation, Seoul (KR)

(72) Inventor: Gyeong Seok Lee, Hwaseong-si (KR)

(21) Appl. No.: 19/203,421

(22) Filed: May 9, 2025

(30) Foreign Application Priority Data
Jan. 31, 2025 (KR) 10-2025-0012419

(51) Int. Cl. B62D 25/02; B60K 1/04; B62D 21/15; B62D 25/20

(52) U.S. Cl. CPC B62D 25/025; B60K 1/04; B62D 21/157; B62D 25/2036; B60K 2001/0438; B60Y 2200/91; B60Y 2306/01

(57) ABSTRACT

A vehicle body structure can include a floor panel, a side sill connected to the floor panel, wherein the side sill can include an external side sill, an internal side sill coupled to the external side sill and connected to the floor panel, and a first reinforcing member coupled to the internal side sill, and wherein the first reinforcing member supports a region in which the floor panel and the internal side sill meet.

### CROSS-REFERENCE TO RELATED APPLICATIONS

This application claims benefit of priority to Korean Patent Application No. 10-2025-0012419 filed on January 31, 2025 in the Korean Intellectual Property Office, the disclosure of which is incorporated herein by reference in its entirety.

### TECHNICAL FIELD

The present disclosure relates to a vehicle body structure.

### BACKGROUND

As interest in eco-friendly vehicles has increased, interest in electric vehicles has also increased. An electric vehicle may need to have structural stability such that a battery may be safely supported and impact may be safely absorbed in the event of a collision, and a battery may need to be easily replaced and repaired.

Generally, when aluminum extrusions are used in a side sill, structural connectivity with other body parts may degrade, the issues of corrosion and increased costs may occur due to the use of different materials, and freedom in design of a vehicle body structure may decrease. Also in the case of an electric vehicle using a battery pack, there may be a risk of damage to the battery pack as a lower portion of a side sill may be penetrated in the event of collision.

### SUMMARY

An embodiment of the present disclosure can provide a vehicle body structure that may absorb an external force by using a plurality of reinforcing members.

An embodiment of the present disclosure can provide a vehicle body structure that may increase design freedom of a side sill and productivity by using a plurality of reinforcing members.

An embodiment of the present disclosure can provide a vehicle body structure that may protect a battery pack by increasing external force absorption of a side sill.

According to an embodiment of the present disclosure, a vehicle body structure can include: a side sill; and a floor panel connected to the side sill, wherein the side sill includes an external side sill, an internal side sill coupled to the external side sill and connected to the floor panel, and a first reinforcing member coupled to the internal side sill, and wherein the first reinforcing member supports a region in which the floor panel and the internal side sill meet.

The side sill may have an internal space defined by the external side sill and the internal side sill, and the first reinforcing member may be positioned in the internal space.

The side sill may further include a second reinforcing member positioned in the internal space and having a cantilever shape in which one side thereof is coupled to the internal side sill.

The other side of the second reinforcing member may extend in the same direction as the first reinforcing member.

The side sill may further include a third reinforcing member positioned between the first reinforcing member and the second reinforcing member, and an extension direction of the third reinforcing member may be the same as an extension direction of the floor panel.

A level of the floor panel may be the same as a level of the third reinforcing member.

The side sill may further include a fourth reinforcing member connecting the first reinforcing member to the second reinforcing member, and one side of the fourth reinforcing member may be positioned between the first reinforcing member and the third reinforcing member.

The other side of the fourth reinforcing member may be connected to the second reinforcing member, and the fourth reinforcing member may include a bent portion, bent toward the third reinforcing member.

The side sill may further include a fifth reinforcing member coupled to the second reinforcing member, the fifth reinforcing member may be positioned between the second reinforcing member and the external side sill in the internal space, and the fifth reinforcing member may be spaced apart from the external side sill.

The side sill may further include a sixth reinforcing member coupled to the floor panel and the internal side sill, and the internal side sill may be positioned between the first reinforcing member and the sixth reinforcing member.

The side sill may further include a seventh reinforcing member positioned in the internal space and coupled to the first reinforcing member, and the seventh reinforcing member may include an internal reinforcing member extending in a direction intersecting an extension direction of the first reinforcing member.

### BRIEF DESCRIPTION OF THE DRAWINGS

The above and other features and advantages of example embodiments of the present disclosure can be more clearly understood from the following detailed description, taken in conjunction with the accompanying drawings, in which:

FIG. 1 is a perspective diagram illustrating a vehicle body structure according to an embodiment of the present disclosure;

FIG. 2 is a cross-sectional diagram illustrating a portion of a vehicle body structure according to an embodiment of the present disclosure;

FIG. 3 is a cross-sectional diagram illustrating a portion of a vehicle body structure according to an embodiment of the present disclosure;

FIG. 4 is a cross-sectional diagram illustrating a portion of a vehicle body structure according to an embodiment of the present disclosure;

FIG. 5 is a cross-sectional diagram illustrating a portion of a vehicle body structure according to an embodiment of the present disclosure; and

FIG. 6 is a cross-sectional diagram illustrating a portion of a vehicle body structure according to an embodiment of the present disclosure.

### DETAILED DESCRIPTION OF ILLUSTRATIVE EMBODIMENTS

Hereinafter, example embodiments of the present disclosure will be described with reference to the attached drawings.

Various example embodiments will be described with reference to accompanying drawings. However, the present disclosure is not necessarily limited to the scopes of the example embodiments and a specific embodiment form. Instead, modifications, equivalents, and replacements included in the disclosed concepts and technical scopes of the present disclosure may be employed. Throughout the specification, similar reference numerals can be used for similar elements.

Further, the terms “first,” “second,” and the like, may be used to distinguish one element from the other, and may not necessarily limit a sequence and/or an importance, or others, in relation to the elements. In some cases, a first element may be referred to as a second element, and similarly, a second element may be referred to as a first element without departing from the scopes of rights of the present disclosure.

The terms “part,” “portion,” or the like, may be used to describe various components, but the components are not necessarily limited by such terms. Such terms may refer to physically/visibly distinct components, and also to terms describing the function or configuration of a part even when the distinction/division is not necessarily clear, for example.

An expression used in the singular can encompass the expression of the plural, unless it has a clearly different meaning in the context. The terms, “include,” “comprise,” “is configured to,” or the like, of the description are used to indicate the presence of features, numbers, steps, operations, elements, parts, or combinations thereof, and do not exclude the possibilities of combination or addition of one or more features, numbers, steps, operations, elements, parts, or combination thereof.

Unless otherwise indicated, terms used herein, including technical or scientific terms, may mean the same as that which would be commonly understood by a person of ordinary skill in the art to which the present disclosure belongs. Terms defined in commonly used dictionaries can be interpreted as having meanings consistent with the context of the relevant technology.

In the description below, the terms “front,” “rear,” “side,” “back,” “upper and lower,” “top,” “left and right,” or the like, used in relation to direction are defined with respect to a vehicle or a vehicle body structure VB. Also, the terms “first” and “second,” or the like, may be used to describe various components, but these components are not limited in order, size, position, or importance by the terms, and are denoted only for the purpose of distinguishing one component from another.

In the drawings, D1 may be referred to as a first direction D1, D2 intersecting the first direction D1 may be referred to as a second direction D2, and D3 intersecting each of the first direction D1 and the second direction D2 may be referred to as a third direction D3. The third direction D3 may be referred to as the upward direction, and the opposite direction of the third direction D3 may be referred to as the downward direction. Also, each of the first direction D1 and the second direction D2 may be referred to as the horizontal direction.

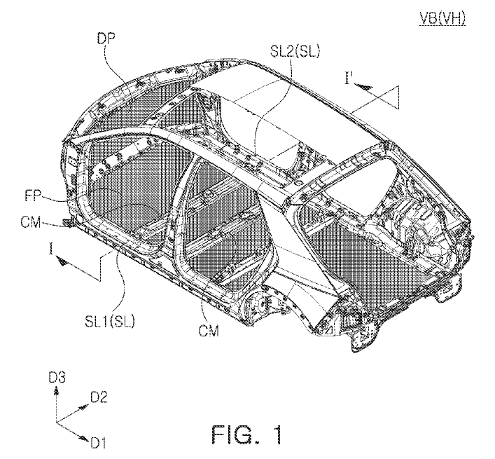

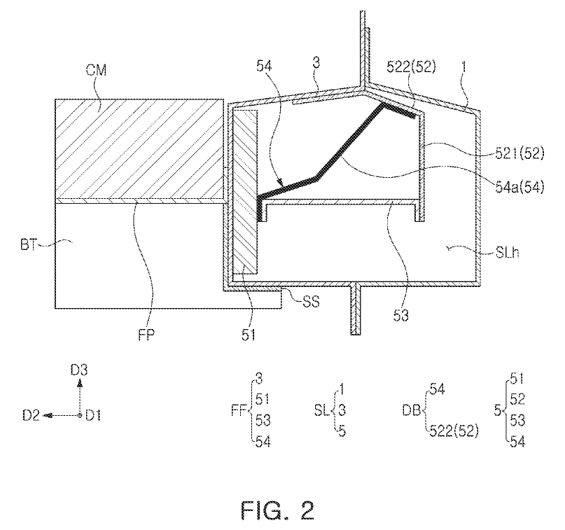

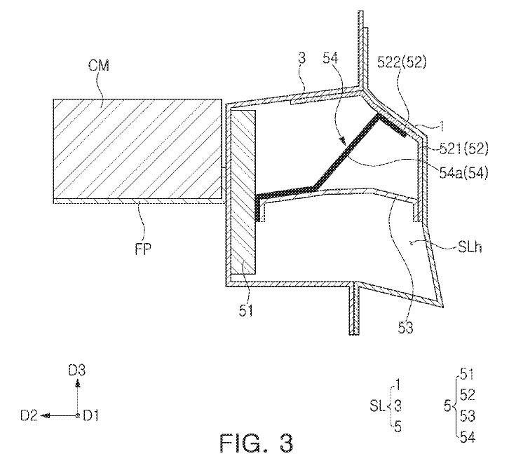

FIG. 1 is a perspective diagram illustrating a vehicle body structure VB according to an example embodiment of the present disclosure. FIG. 2 is a cross-sectional diagram illustrating a portion of a vehicle body structure VB according to an example embodiment of the present disclosure. FIG. 3 is a cross-sectional diagram illustrating a portion of a vehicle body structure VB according to an example embodiment of the present disclosure. FIG. 2 is a portion of a cross-sectional diagram of the vehicle body structure VB taken along line I-I’.

The vehicle body structure VB may support various devices installed in the vehicle VH. For example, the vehicle body structure VB may be coupled to and support various parts such as a seat, various electronic devices used for driving the vehicle VH, a console, a vehicle wheel, a suspension, or the like.

Referring to FIGS. 1 and 2, the vehicle body structure VB according to an embodiment may include a side sill SL, and a floor panel FP. According to an embodiment, the side sill SL may include an internal side sill 3, an external side sill 1, and a reinforcing member 5. According to an embodiment, the reinforcing member 5 may include a first reinforcing member 51. According to an embodiment, the reinforcing member 5 may optionally include a second reinforcing member 52, a third reinforcing member 53, and a fourth reinforcing member 54. According to an embodiment, the vehicle body structure VB may optionally include a dash panel DP, a sealer SS, a battery pack BT, and a seat cross member CM.

The dash panel DP may work as a wall physically separating an engine room of the vehicle VH from a cabin, which is a space in which passengers board. The dash panel DP may be positioned on the front side of the vehicle VH. The dash panel DP may block heat, noise, and vibration of the engine room and may ensure passenger safety. Also, the dash panel DP may reduce cabin deformation by absorbing and dispersing impact during collision from the front or side. The dash panel DP may be coupled to various parts such as a heating, ventilation, and air conditioning (HVAC) system, a steering column, or the like, and may provide stability and convenience to the driver. The dash panel DP may be coupled to the side sill SL and A-pillar of the vehicle VH. The dash panel DP may include at least one of high-strength steel, aluminum alloy, and a composite material, but an embodiment thereof is not necessarily limited thereto.

The side sill SL may be a part extending along the periphery of a lower portion of the vehicle body structure VB. The side sill SL may be connected to a bottom edge of both sides of the cabin. The side sill SL may connect an inner part of the vehicle VH to an outer door frame. The side sill SL may protect a passenger by dispersing and absorbing external force during collision of the vehicle VH from the side. External force may include collision energy. Also, the side sill SL may transfer the load of the vehicle VH to the battery pack BT and/or a subframe, or the like, and may ensure balance and structural stability of the vehicle VH.

The side sill SL may be connected to the dash panel DP. The side sill SL may include a first side sill SL1 and a second side sill SL2 connected to the dash panel DP. The first side sill SL1 may be connected to one side (e.g., left side) of the dash panel DP. The second side sill SL2 may be connected to the other side (e.g., right side) of the dash panel DP. The first side sill SL1 and the second side sill SL2 may extend in the first direction D1. The first side sill SL1 and the second side sill SL2 may be spaced apart from each other in the second direction D2 perpendicular to the first direction D1. In the description below, the description of the side sill SL may be applied to either or both of the first side sill SL1 and the second side sill SL2.

Referring to FIGS. 1 and 2, the side sill SL according to an embodiment may include an external side sill 1, an internal side sill 3 and a reinforcing member 5. The reinforcing member 5 according to an embodiment may include a first reinforcing member 51. The reinforcing member 5 according to an embodiment may optionally include a second reinforcing member 52, a third reinforcing member 53, and a fourth reinforcing member 54.

The external side sill 1 may form a portion of the vehicle VH exterior. The external side sill 1 may protect the exterior of the vehicle VH and may reduce an external force transferred into the vehicle body structure VB by absorbing external impact. The external side sill 1 may protect the internal structure from external corrosion and damage. The external side sill 1 may include a high-strength steel plate or an aluminum alloy, but an embodiment thereof is not necessarily limited thereto.

The internal side sill 3 may be coupled to the external side sill 1. The internal side sill 3 may be positioned closer to a center of the vehicle VH than the external side sill 1. When the vehicle VH collides, the internal side sill 3 may reduce deformation of the vehicle body structure VB and may contribute to maintaining a safe space for passengers. The internal side sill 3 may effectively distribute the load and may increase structural rigidity of the vehicle VH. The internal side sill 3 may include a metal material, and may be connected to the external side sill 1 and may reinforce the frame structure of the vehicle VH.

The external side sill 1 and the internal side sill 3 may have an internal space SLh. The internal space SLh may be a spacing between the external side sill 1 and the internal side sill 3. The internal space SLh may be defined by the external side sill 1 and the internal side sill 3. The side sill SL may absorb external impact and may have a light weight due to the internal space SLh.

The reinforcing member 5 may be positioned in the internal space SLh. The reinforcing member 5 may be coupled to the side sill SL. The reinforcing member 5 may be directly or indirectly coupled to at least one of the external side sill 1 and the internal side sill 3. Rigidity of the side sill SL may be improved due to the reinforcing member 5, and structural stability of the vehicle body structure VB may be improved. The reinforcing member 5 may extend in the first direction D1 similarly to the side sill SL. The first reinforcing member 51, the second reinforcing member 52, the third reinforcing member 53, and the fourth reinforcing member 54 will be described later.

The floor panel FP may be positioned at the lower portion of the vehicle VH and may evenly distribute the load. The floor panel FP may be coupled to various components of the vehicle body structure VB, such that the floor panel FP may distribute the load and may absorb the impact, thereby protecting a passengers and cargo.

The floor panel FP according to an embodiment may include a front floor, a center floor, and a rear floor. The front floor may be positioned on lower ends of a driver seat and a passenger seat of the vehicle VH. The front floor may divide the space between the engine room and a passenger room. The center floor may be included in the central portion of the vehicle VH and may connect the front floor to the rear floor. The center floor may distribute the load applied to the entire vehicle body structure VB. The rear floor may be positioned on the rear side of the vehicle VH. The rear floor may support a cargo loading space. The rear floor may be designed to withstand the trunk load and may have impact dissipation capability.

The floor panel FP may be coupled to the seat cross member CM. The seat cross member CM may be coupled to the floor panel FP. The seat cross member CM may indicate a structure protruding upwardly from the floor panel FP. The seat cross member CM may provide a space through which parts such as a drive shaft, an exhaust pipe, a battery pack BT, and electrical wiring can pass through. The use of the internal space of the vehicle VH may be increased by the seat cross member CM. The seat cross member CM may absorb external force when the vehicle VH collides. The seat cross member CM may connect the side sills SL positioned on both sides of the dash panel DP to each other. The seat cross member CM may connect the first side sill SL1 to the second side sill SL2. The seat cross member CM may extend in the second direction D2.

Next, the first reinforcing member 51, the second reinforcing member 52, the third reinforcing member 53, and the fourth reinforcing member 54 will be described.

The first reinforcing member 51 may be positioned in the internal space SLh. The first reinforcing member 51 may be coupled to the internal side sill 3. The internal side sill 3 may be positioned between the first reinforcing member 51 and the floor panel FP. The first reinforcing member 51 may have a cross-section extending in the vertical direction. The first reinforcing member 51 may have a cross-section extending in the third direction D3. Hereinafter, the extension directions of the entirety of the reinforcing members 5 including the first reinforcing member 51 may indicate the extension directions to the second direction D2 and the third direction D3. To describe and compare the shapes of various sorts of the reinforcing members 5, the extension directions of the reinforcing member 5 may indicate the extension directions of a cross-section of the reinforcing member 5.

Referring to FIG. 2, the first reinforcing member 51 may support a region in which the floor panel FP and the internal side sill 3 meet. A coupling surface between the first reinforcing member 51 and the internal side sill 3 may overlap or underlap a coupling surface between the floor panel FP and the internal side sill 3. A level of the floor panel FP may be higher than a level of a lower surface of the first reinforcing member 51. A level of the floor panel FP may be lower than a level of an upper surface of the first reinforcing member 51. The first reinforcing member 51 may be coupled to an innermost side of the internal side sill 3.

FIG. 3 is a diagram illustrating a state in which the side sill SL and the floor panel FP received impact upon collision of the vehicle VH. For ease of description, the sealer SS and the battery pack BT are not illustrated in FIG. 3. Referring to FIG. 3, the floor panel FP may be bent. The first reinforcing member 51 may prevent the floor panel FP from penetrating into the side sill. The first reinforcing member 51 may prevent the side sill SL from damaging the floor panel FP. The first reinforcing member 51 may have a constant thickness (which may be much thicker than the internal side sill 3), and may support the internal side sill 3.

The second reinforcing member 52 may be positioned in the internal space SLh. The second reinforcing member 52 may be coupled to the internal side sill 3. The second reinforcing member 52 may have a cantilever shape in which one side thereof is coupled to the internal side sill 3. The other side of the second reinforcing member 52, positioned opposite to one side of the second reinforcing member 52, may be spaced apart from the internal side sill 3

The second reinforcing member 52 according to an embodiment may include a 2-1 reinforcing member 521 and a 2-2 reinforcing member 522. The 2-1 reinforcing member 521 may extend in the same direction as the first reinforcing member 51. More specifically, the 2-1 reinforcing member 521 may extend in the height direction of the first reinforcing member 51. The 2-1 reinforcing member 521 may extend in the third direction D3. The 2-1 reinforcing member 521 may be spaced apart from the internal side sill 3. The 2-1 reinforcing member 521 may include the other side of the second reinforcing member 52. The 2-1 reinforcing member 521 may be connected to the 2-2 reinforcing member 522. The 2-2 reinforcing member 522 may connect the internal side sill 3 to the 2-1 reinforcing member 521. The 2-2 reinforcing member 522 may be coupled to the internal side sill 3. The 2-2 reinforcing member 522 may include one side of the second reinforcing member 52. A slope of the 2-1 reinforcing member 521 may be greater than a slope of the 2-2 reinforcing member 522. However, the relationship between the slope of the 2-1 reinforcing member 521 and the slope of the 2-2 reinforcing member 522 is necessarily not limited thereto.

The third reinforcing member 53 may be positioned in the internal space SLh. The third reinforcing member 53 may be positioned between the first reinforcing member 51 and the second reinforcing member 52. More specifically, one side of the third reinforcing member 53 may be connected to the first reinforcing member 51. The other side of the third reinforcing member 53, positioned opposite to one side of the third reinforcing member 53, may be connected to the second reinforcing member 52. The other side of the third reinforcing member 53 may be connected to the 2-1 reinforcing member 521. The extension direction of the third reinforcing member 53 may be the same as the extension direction of the floor panel FP.

A level of the third reinforcing member 53 may be the same as a level of the floor panel FP. However, the relationship between the level of the third reinforcing member 53 and the level of the floor panel FP is not necessarily limited thereto.

The fourth reinforcing member 54 may be positioned in the internal space SLh. The fourth reinforcing member 54 may connect the first reinforcing member 51 to the second reinforcing member 52. More specifically, one side of the fourth reinforcing member 54 may be connected to the first reinforcing member 51. One side of the fourth reinforcing member 54 and the 2-2 reinforcing member 522 may have a double frame structure DB. The other side of the fourth reinforcing member 54, positioned opposite to one side of the fourth reinforcing member 54, may be connected to the second reinforcing member 52. The other side of the fourth reinforcing member 54 may be connected to the 2-2 reinforcing member 522. The other side of the fourth reinforcing member 54, one side of the third reinforcing member 53, the first reinforcing member 51 and the internal side sill 3 may be connected to each other and may have the fourth reinforcing member FF.

Referring to FIG. 2, one side of the fourth reinforcing member 54 may be positioned between the first reinforcing member 51 and the third reinforcing member 53. The third reinforcing member 53 may be indirectly connected to the first reinforcing member 51 by the fourth reinforcing member 54.

The fourth reinforcing member 54 may extend in a diagonal direction. The diagonal direction may indicate a direction including both the second direction D2 and the third direction. Alternatively, the diagonal direction may indicate a direction including both the opposite direction of the second direction D2 and the third direction D3. The diagonal direction may intersect the extension direction of the first reinforcing member 51.

Referring to FIG. 2, the fourth reinforcing member 54 may include a bent portion 54a. The bent portion 54a may be positioned between one side of the fourth reinforcing member 54 and the other side of the fourth reinforcing member 54. The bent portion 54a may have a shape bent toward the third reinforcing member 53. The bent portion may have a shape outwardly bent toward the third reinforcing member 53.

Referring to FIG. 3, when the vehicle VH collides, the external side sill 1 may receive an external force applied in the second direction D2. The second reinforcing member 52 may receive the external force transferred by the external side sill 1. The 2-2 reinforcing member 522 may bend by the external force and may absorb the impact. The fourth reinforcing member 54 connected to the 2-2 reinforcing member 522 may prevent deformation of the 2-2 reinforcing member 522 and may absorb the impact caused by the external force. The third reinforcing member 53 may also bend while receiving the external force applied in the second direction D2. The bent portion 54a of the fourth reinforcing member 54 may prevent the third reinforcing member 53 from bending upwardly and may absorb the impact caused by the external force, thereby preventing deformation of the side sill SL. The first reinforcing member 51 may prevent the floor panel FP and the side sill SL from interfering each other and causing damage as described above.

A sealer SS may couple the floor panel FP to the internal side sill 3. The sealer SS may connect the floor panel FP, the side sill SL and the battery pack BT to each other. The sealer SS may maintain airtightness at a bonding region between different parts and may block infiltration of air, water, dust, or the like. The sealer SS may reinforce structural rigidity at the bonding region of the vehicle VH and may absorb and disperse impact when applied. The sealer SS according to an embodiment may include at least one of a polyurethane-based sealer, a silicone-based sealer, an epoxy-based sealer, or a rubber-based sealer, but the type of the sealer SS is not necessarily limited thereto. The position of the sealer SS in FIG. 2 is an example, and the sealer SS may be positioned in an arbitrary position of the vehicle VH.

A battery pack BT may supply power by converting chemical energy into electrical energy to the driving motor and electrical parts of the vehicle VH. The battery pack BT may control voltage, current, and temperature in real time through the BMS (battery management system). The battery pack BT may include cells, an internal insulating material, cooling channels, a battery housing, or the like. The cell may be a basic structure of the battery pack BT including a cathode, an electrolyte, and a separator, may convert chemical energy into electrical energy, and may release or store the energy. Depending on the shape of the cell package surrounding the cell, one of an angular shape, a cylindrical shape, and a pouch shape may be included, but the shape of the cell package is not limited thereto.

The battery pack BT may be coupled to the floor panel FP. The battery pack BT may be positioned below the floor panel FP. At least a portion of the battery pack BT may be coupled to the internal side sill 3.

Hereinafter, for ease of description, the battery pack BT and the sealer SS may not be illustrated. In an embodiment, the battery pack BT and the sealer SS may be provided independently regardless of the shape of the internal side sill 3, the battery pack BT, the floor panel FP, and the seat cross member CM.

However, the configuration and the shape of the side sill SL including the reinforcing member 5 are not necessarily limited thereto. Next, the vehicle body structure VB including the side sill SL having various structures will be described.

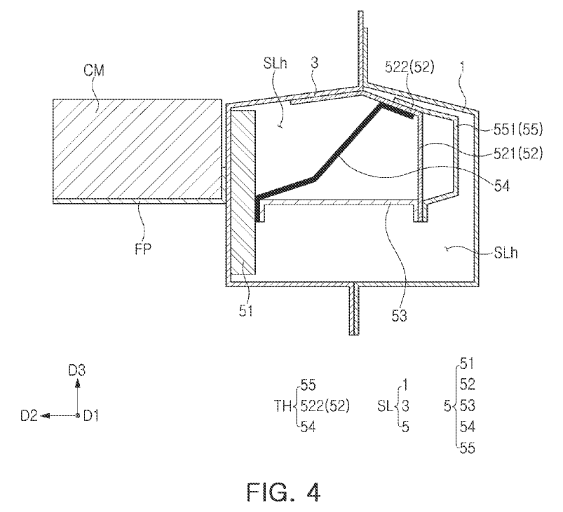

FIG. 4 is a cross-sectional diagram illustrating a portion of vehicle body structure VB according to an example embodiment of the present disclosure.

Referring to FIG. 4, a side sill SL according to an embodiment may optionally further include a fifth reinforcing member 55. The fifth reinforcing member 55 may be positioned in the internal space SLh. The fifth reinforcing member 55 may be coupled to the second reinforcing member 52. One side of the fifth reinforcing member 55 may be connected to the 2-1 reinforcing member 521. The other side of the fifth reinforcing member 55, positioned opposite to one side of the fifth reinforcing member 55, may be connected to the 2-2 reinforcing member 522. The other side of the fifth reinforcing member 55, the 2-2 reinforcing member 522 and the other side of the fourth reinforcing member 54 may be connected to each other and may have a triple frame structure TH.

The fifth reinforcing member 55 may be positioned between the second reinforcing member 52 and the external side sill 1. However, the fifth reinforcing member 55 may be spaced apart from the external side sill 1 by a set, selected, or predetermined distance.

The fifth reinforcing member 55 may include a 5-1 reinforcing member 551 positioned between one side of the fifth reinforcing member 55 and the other side of the fifth reinforcing member 55. The 5-1 reinforcing member 551 may extend in the same direction as the extension direction of the 2-1 reinforcing member 521. The 5-1 reinforcing member 551 may be spaced apart from the 2-1 reinforcing member 521. The 5-1 reinforcing member 551 may be spaced apart from the external side sill 1.

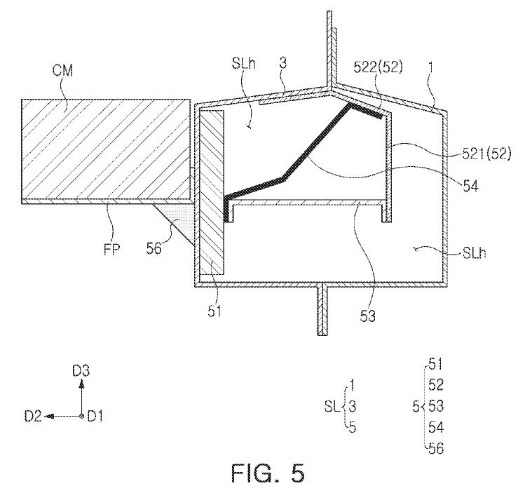

FIG. 5 is a cross-sectional diagram illustrating a portion of a vehicle body structure VB according to an example embodiment of the present disclosure .

Referring to FIG. 5, the side sill SL according to an embodiment may optionally further include a sixth reinforcing member 56. The sixth reinforcing member 56 may be coupled to the floor panel FP. The sixth reinforcing member 56 may be coupled to the internal side sill 3. The internal side sill 3 may be positioned between the first reinforcing member 51 and the sixth reinforcing member 56. The sixth reinforcing member 56 may support the region in which the floor panel FP and the internal side sill 3 are coupled to each other.

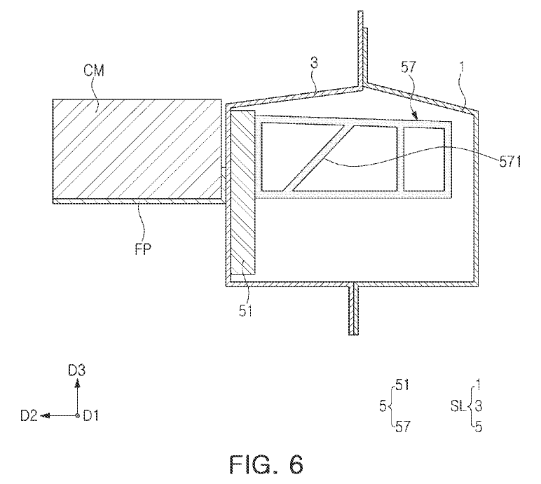

FIG. 6 is a cross-sectional diagram illustrating a portion of a vehicle body structure VB according to an example embodiment of the present disclosure .

Referring to FIG. 6, the side sill SL may include a seventh reinforcing member 57 instead of the second reinforcing member 52, the third reinforcing member 53, and the fourth reinforcing member 54. The seventh reinforcing member 57 may be positioned in the internal space SLh. The seventh reinforcing member 57 may be coupled to the first reinforcing member 51. The seventh reinforcing member 57 may have a cantilever shape in which one side thereof is coupled to the first reinforcing member 51 and the other side is not supported by another structure. A level of the seventh reinforcing member 57 may be a level of the floor panel FP or higher. The level of the seventh reinforcing member 57 may be the level of an upper surface of the first reinforcing member 51 or lower.

The seventh reinforcing member 57 may have a hollow column shape therein. The seventh reinforcing member 57 may include an internal reinforcing member 571. The internal reinforcing member 571 may extend in a diagonal direction. The internal reinforcing member 571 may absorb an external force applied in a horizontal direction and an external force applied in a vertical direction.

For a vehicle body structure VB according to the example embodiments of the present disclosure, rigidity of the vehicle body structure VB may be increased. More specifically, bending rigidity of the side sill may be increased such that the vehicle body structure VB may protect the battery pack BT and passengers, or the like. The first reinforcing member 51 may support a contact region between the floor panel FP and the internal side sill 3. The first reinforcing member 51 may prevent the floor panel FP and the side sill SL from interfering with each other and being damaged. The second reinforcing member 52 and the third reinforcing member 53 may absorb external force applied in the lateral direction. The fourth reinforcing member 54 may connect the second reinforcing member 52 to the third reinforcing member 53, such that the second reinforcing member 52 and the third reinforcing member 53 may interfere with each other and may be deformed. The plurality of reinforcing members 5 may interfere with and support each other and may absorb external force, thereby increasing safety of the battery pack BT and passengers.

For a vehicle body structure VB according to the example embodiments of the present disclosure, the design of the vehicle body structure VB may be facilitated and may be economical. As described above, the side sill SL may include one of various reinforcing members 5 coupled to the internal side sill 3 and the external side sill 1. The reinforcing member 5 may have various shapes. The reinforcing member 5 may have various shapes to effectively absorb the external force. By disposing the necessary reinforcing member 5 in the internal space SLh without filling the internal space SLh to increase rigidity of the vehicle VH, the weight of the vehicle VH may be reduced, and fuel efficiency may increase. Also, because the materials for manufacturing the vehicle body structure VB can be reduced as compared to when filling the internal space SLh, the manufacturing cost of the vehicle body structure VB may be reduced.

According to the aforementioned example embodiments, the vehicle body structure may absorb external force by using a plurality of reinforcing members.

The vehicle body structure according to an embodiment may increase design freedom of the side sill and may increase productivity by using a plurality of reinforcing members.

The vehicle body structure according to an embodiment may protect the battery pack by increasing the external force absorption of the side sill.

A number of embodiments have been disclosed herein. It can be understood that various features of the different embodiments can be combined.

While example embodiments have been illustrated and described above, it can be apparent to those skilled in the art that modifications and variations could be manufactured without departing from the scopes of the present disclosure as defined by the appended claims, and equivalents thereof.

What is claimed is:

1. A vehicle body structure, comprising:
a floor panel; and
a side sill connected to the floor panel, wherein the side sill comprises:
an external side sill,
an internal side sill coupled to the external side sill and connected to the floor panel, and
a first reinforcing member coupled to the internal side sill, wherein the first reinforcing member supports a region in which the floor panel and the internal side sill meet.

2. The vehicle body structure of claim 1, wherein the side sill includes an internal space defined by the external side sill and the internal side sill, and
wherein the first reinforcing member is positioned in the internal space.

3. The vehicle body structure of claim 2, wherein the side sill further comprises a second reinforcing member positioned in the internal space and having a cantilever shape in which a first second-reinforcing-member side thereof is coupled to the internal side sill.

4. The vehicle body structure of claim 3, wherein a second second-reinforcing-member side of the second reinforcing member extends in a same direction as the first reinforcing member.

5. The vehicle body structure of claim 3, wherein the side sill further comprises a third reinforcing member positioned between the first reinforcing member and the second reinforcing member, and
wherein a third-reinforcing-member extension direction of the third reinforcing member is a same extension direction as a floor-panel extension direction of the floor panel.

6. The vehicle body structure of claim 5, wherein a floor-panel level of the floor panel is a same level as a third-reinforcing-member level of the third reinforcing member.

7. The vehicle body structure of claim 5, wherein the side sill further comprises a fourth reinforcing member connecting the first reinforcing member to the second reinforcing member, and
wherein a first fourth-reinforcing-member side of the fourth reinforcing member is positioned between the first reinforcing member and the third reinforcing member.

8. The vehicle body structure of claim 7, wherein a second fourth-reinforcing-member side of the fourth reinforcing member is connected to the second reinforcing member, and
wherein the fourth reinforcing member includes a bent portion being bent toward the third reinforcing member.

9. The vehicle body structure of claim 3, wherein the side sill further comprises a fifth reinforcing member coupled to the second reinforcing member,
wherein the fifth reinforcing member is positioned between the second reinforcing member and the external side sill in the internal space, and
wherein the fifth reinforcing member is spaced apart from the external side sill.

10. The vehicle body structure of claim 9, wherein the fifth reinforcing member includes a vertical extending portion that is spaced apart from the second reinforcing member.

11. The vehicle body structure of claim 1, wherein the side sill further comprises a sixth reinforcing member coupled to the floor panel and the internal side sill, and
wherein the internal side sill is positioned between the first reinforcing member and the sixth reinforcing member.

12. The vehicle body structure of claim 2, wherein the side sill further comprises a seventh reinforcing member positioned in the internal space and coupled to the first reinforcing member, and
wherein the seventh reinforcing member includes an internal reinforcing member extending in a direction intersecting an extension direction of the first reinforcing member.

13. A vehicle body structure, comprising:
a floor panel; and
a side sill connected to the floor panel, wherein the side sill comprises:
an external side sill,
an internal side sill coupled to the external side sill and connected to the floor panel, wherein the side sill includes an internal space defined by the external side sill and the internal side sill, and
a first reinforcing member coupled to the internal side sill, wherein the first reinforcing member is positioned in the internal space.

14. A vehicle body structure, comprising:
a floor panel; and
a side sill connected to the floor panel, wherein the side sill comprises:
an external side sill,
an internal side sill coupled to the external side sill and connected to the floor panel, wherein the side sill includes an internal space defined by the external side sill and the internal side sill,
a first reinforcing member coupled to the internal side sill, wherein the first reinforcing member is positioned in the internal space,
a second reinforcing member positioned in the internal space and having a cantilever shape in which a first second-reinforcing-member side thereof is coupled to the internal side sill,
a third reinforcing member positioned between the first reinforcing member and the second reinforcing member, and
a fourth reinforcing member connecting the first reinforcing member to the second reinforcing member, wherein a first fourth-reinforcing-member side of the fourth reinforcing member is positioned between the first reinforcing member and the third reinforcing member.

15. The vehicle body structure of claim 14, wherein the side sill further comprises a fifth reinforcing member coupled to the second reinforcing member,
wherein the fifth reinforcing member is positioned between the second reinforcing member and the external side sill in the internal space, and
wherein the fifth reinforcing member is spaced apart from the external side sill.

16. The vehicle body structure of claim 14, wherein the side sill further comprises a sixth reinforcing member coupled to the floor panel and the internal side sill, and
wherein the internal side sill is positioned between the first reinforcing member and the sixth reinforcing member.

17. The vehicle body structure of claim 14, wherein a second second-reinforcing-member side of the second reinforcing member extends in a same direction as the first reinforcing member.

18. The vehicle body structure of claim 14, wherein a third-reinforcing-member extension direction of the third reinforcing member is a same extension direction as a floor-panel extension direction of the floor panel.

19. The vehicle body structure of claim 14, wherein a floor-panel level of the floor panel is a same level as a third-reinforcing-member level of the third reinforcing member.

20. The vehicle body structure of claim 14, wherein a second fourth-reinforcing-member side of the fourth reinforcing member is connected to the second reinforcing member, and wherein the fourth reinforcing member includes a bent portion.
